(19) United States
(12) Patent Application Publication
(10) Pub. No.: US 2014/0017033 A1
(43) Pub. Date: Jan. 16, 2014

(54) SELF-TAPPING SCREW

(71) Applicant: Shih-An TSAI, Kunshan City (CN)

(72) Inventor: Shih-An TSAI, Kunshan City (CN)

(73) Assignee: HAMA NAKA MOTOGAWA METAL PRODUCT (KUNSHAN) CO., LTD., Kunshan City (CN)

(21) Appl. No.: 13/684,313

(22) Filed: Nov. 23, 2012

(30) Foreign Application Priority Data
Jul. 13, 2012 (CN) 201220341454.1

(51) Int. Cl. F16B 25/10

(52) U.S. Cl. CPC F16B 25/10
USPC 411/387.1

(57) ABSTRACT

A self-tapping screw includes a head, a shank provided on the head and threads provided on the shank, wherein the threads include a first contact surface and a second contact surface forming a thread angle of 40 degrees therebetween. A vertical line from a vertex of the thread angle is drawn perpendicular to the shank, and the first contact surface forms a first inclination angle with the vertical line, and the second contact surface forms a second inclination angle with the vertical line, wherein the first inclination angle is different from the second inclination angle. The present invention can be used to replace mechanical screws as it has a smaller assembly torque suitable for fastening onto lighter objects.

### FIELD OF THE INVENTION

The present invention relates to fasteners, and more particularly, to a self-tapping screw suitable for lightweight alloys.

### BACKGROUND OF THE INVENTION

Screws are a common type of fasteners, among which, self-tapping screws has a wide range of applications as they can directly driven into the workpiece. The specifications for existing self-tapping screws are generally M2 or above, which is not suitable for small electronic products. Also, the thread angle of existing self-tapping screws is normally 60 degrees, making the assembly torque too large when in use. As a result, self-tapping screws are impractical for lightweight metal alloys.

### SUMMARY OF THE INVENTION

In light of the foregoing drawbacks of the prior art, objectives of the present invention is to provide a self-tapping screw having a smaller thread angle and a smaller pitch, thus having a smaller assembly torque that can be used to replace mechanical screws.

In order to achieve the above objectives, the present invention employs the following technical solution. A self-tapping screw includes a head, a shank provided on the head and threads provided on the shank, wherein the threads include a first contact surface and a second contact surface forming a thread angle of 40 degrees therebetween.

Preferably, a vertical line from a vertex of the thread angle is drawn perpendicular to the shank, and the first contact surface forms a first inclination angle with the vertical line, and the second contact surface forms a second inclination angle with the vertical line, wherein the first inclination angle is different from the second inclination angle.

Preferably, the first inclination angle is larger than the second inclination angle. Further, the first inclination angle is 25 degrees and the second inclination angle is 15 degrees.

Moreover a pitch between the threads is between 0.2 mm to 0.35 mm, and a depth of the threads is between 0.8 mm to 5.0 mm.

In the self-tapping screw of the present invention, the thread angle is designed to be 40 degrees to reduce the friction between the contact surfaces of the threads and an object to be fastened as well as tapping torque, so that the screw can be smoothly driven into the object. By reducing the thread pitch to be in consistent with the mechanical threads, the crest mating area of the screw threads is able to produce a greater clamping force, preventing wear of the internal threads when the screw is attached to lighter alloy objects or when the internal threads are shorter.

By designing the first inclined angle to be 25°, which is greater than the second inclination angle of 15°, the friction between the contact surfaces of the threads and the object to be fastened can be reduced, and thus reducing tapping torque and allowing the threads and the external threads to self tap into the object and have a 100% fit with the object. Since the contact surfaces of the threads have a 100% fit with the object, breakaway torque is increased and loosening of the screw can be prevented. Furthermore, by increasing the cross-sectional area of the threads by 30%, breaking torque of the internal threads is increased, thereby increasing the life of the screw, i.e. increasing the number of repeated use by about 50%.

With the above technical solutions, the present invention has the following beneficial effects: the self-tapping screw offers both a smaller thread angle and a smaller pitch, while requiring a smaller assembly torque suitable for fastening onto lighter alloy objects. It also has a longer service life.

### BRIEF DESCRIPTION OF THE DRAWINGS

FIG. 1 is a schematic diagram depicting a structure in accordance with an embodiment of the present invention;

FIG. 2 is a schematic diagram depicting a thread angle in an embodiment of the present invention; and

FIG. 3 is a schematic diagram depicting a self-tapping screw in an embodiment of the present invention when fastened.

### DETAILED DESCRIPTION OF THE EMBODIMENTS

The technical schemes of the present invention are described by the following specific embodiments and the attached drawings.

### Embodiment 1

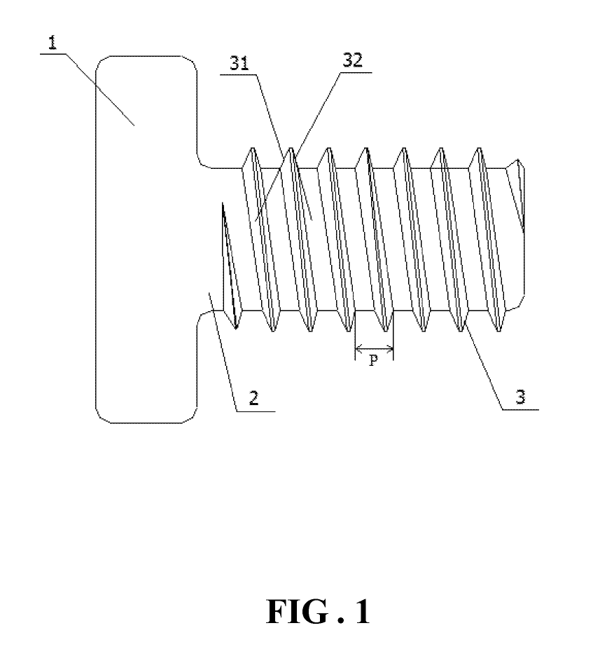

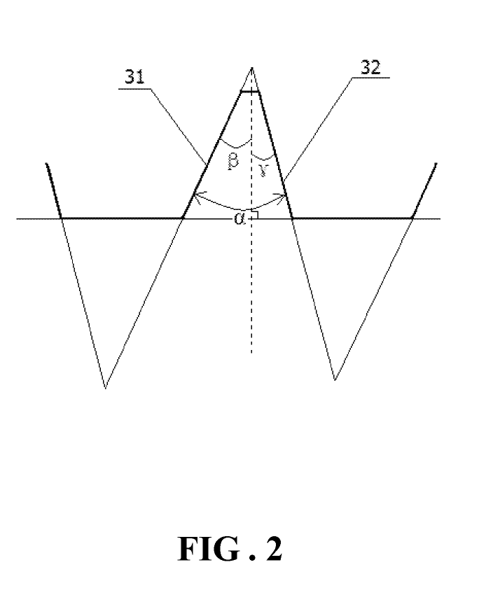

Referring to FIG. 1 and FIG. 2, a self-tapping screw of model no. M0.8 includes a head 1, a shank 2 and threads 3. The head 1 is provided at one end of the shank 2, and the threads 3 including a first contact surface 31 and a second contact surface 32 are provided on the shank 2. The first contact surface 31 and the second contact surface 32 form a thread angle α of 40 degrees. A vertical line from the vertex of the thread angle α can be drawn perpendicular to the shank, and the first contact surface 31 forms a first inclination angle β with the vertical line, and the second contact surface 32 forms a second inclination angle γ with the vertical line, wherein the first inclination angle β is 25° and the second inclination angle γ is 15°. In this embodiment, the thread pitch P is 0.20 mm and the thread depth is 0.8 mm.

### Example 2

Referring to FIG. 1 and FIG. 2, a self-tapping screw of model no. M1.0 includes a head 1, a shank 2 and threads 3. The head 1 is provided at one end of the shank 2, and the threads 3 including a first contact surface 31 and a second contact surface 32 are provided on the shank 2. The first contact surface 31 and the second contact surface 32 form a thread angle α of 40 degrees. A vertical line from the vertex of the thread angle α can be drawn perpendicular to the shank, and the first contact surface 31 forms a first inclination angle β with the vertical line, and the second contact surface 32 forms a second inclination angle γ with the vertical line, wherein the first inclination angle β is 25° and the second inclination angle γ is 15° . In this embodiment, the thread pitch P is 0.25 mm and the thread depth is 1.2 mm.

### Example 3

Referring to FIG. 1 and FIG. 2, a self-tapping screw of model no. M1.4 includes a head 1, a shank 2 and threads 3. The head 1 is provided at one end of the shank 2, and the threads 3 including a first contact surface 31 and a second contact surface 32 are provided on the shank 2. The first contact surface 31 and the second contact surface 32 form a thread angle α of 40 degrees. A vertical line from the vertex of the thread angle α can be drawn perpendicular to the shank, and the first contact surface 31 forms a first inclination angle β with the vertical line, and the second contact surface 32 forms a second inclination angle γ with the vertical line, wherein the first inclination angle β is 25° and the second inclination angle γ is 15°. In this embodiment, the thread pitch P is 0.30 mm and the thread depth is 1.4 mm.

### Example 4

Referring to FIG. 1 and FIG. 2, a self-tapping screw of model no. M1.0 includes a head 1, a shank 2 and threads 3. The head 1 is provided at one end of the shank 2, and the threads 3 including a first contact surface 31 and a second contact surface 32 are provided on the shank 2. The first contact surface 31 and the second contact surface 32 form a thread angle α of 40 degrees. A vertical line from the vertex of the thread angle α can be drawn perpendicular to the shank, and the first contact surface 31 forms a first inclination angle β with the vertical line, and the second contact surface 32 forms a second inclination angle γ with the vertical line, wherein the first inclination angle β is 25° and the second inclination angle γ is 15°. In this embodiment, the thread pitch P is 0.35 mm and the thread depth is 2.0 mm.

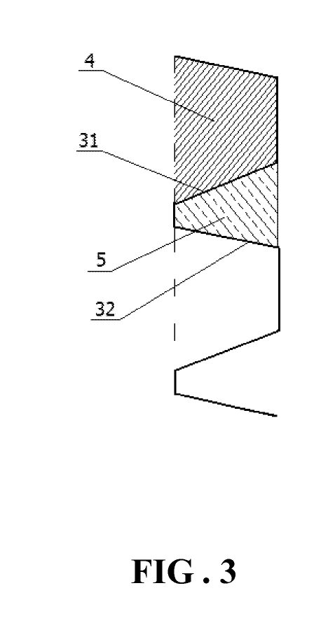

Refer to FIG. 3, when fastening the self-tapping screw of the present invention to an object, since the thread angle is 40 degrees, the ratio of the cross-sectional area of internal threads 4 to the cross-sectional area of external threads 5 is 1.3:1, whereas when attaching a self-tapping screw of the prior art having a thread angle of 60° to an object, the ratio of the cross-sectional area of internal threads to the cross-sectional area of external threads is 1:1. With the change in the thread angle, the cross-sectional area of internal threads of the screw of the present invention when in use is increased by 30%, thereby enhancing breaking torque of the internal threads and thus increasing the service life of the screw.

The above are only embodiments of the present invention, and they should not be construed as to limit the present invention in any way. Those described in the specification and the drawings can be used to make any equivalent changes in structures or processes or applied directly or indirectly to other relevant fields without departing from the scope of the present invention as defined in the following claims.

1. A self-tapping screw comprising a head, a shank provided on the head and threads provided on the shank, wherein the threads include a first contact surface and a second contact surface forming a thread angle of 40 degrees therebetween.

2. The self-tapping screw of claim 1, wherein a vertical line from a vertex of the thread angle is drawn perpendicular to the shank, and the first contact surface forms a first inclination angle with the vertical line, and the second contact surface forms a second inclination angle with the vertical line, wherein the first inclination angle is different from the second inclination angle.

3. The self-tapping screw of claim 1 or 2, wherein the first inclination angle is larger than the second inclination angle.

4. The self-tapping screw of claim 3, wherein the first inclination angle is 25 degrees and the second inclination angle is 15 degrees.

5. The self-tapping screw of claim 3, wherein a pitch between the threads is between 0.2 mm to 0.35 mm, and a depth of the threads is between 0.8 mm to 5.0 mm.
